(19) United States
(12) Patent Application Publication
(10) Pub. No.: US 2024/0385470 A1
(43) Pub. Date: Nov. 21, 2024

(54) LITHIUM-CONTAINING PHOTONICS INTEGRATING PHOTODETECTING MATERIALS

(71) Applicant: HyperLight Corporation, Cambridge, MA (US)

(72) Inventors: Mian Zhang, Cambridge, MA (US); Roy Meade, Bastrop, TX (US); Kevin Luke, Cambridge, MA (US)

(21) Appl. No.: 18/665,412

(22) Filed: May 15, 2024

Related U.S. Application Data
(60) Provisional application No. 63/467,279, filed on May 17, 2023.

(51) Int. Cl. G02F 1/035

(52) U.S. Cl. CPC G02F 1/035; G02F 2202/20

(57) ABSTRACT

A wafer for an integrated photonics system is described. The wafer includes a substrate and at least one thin film lithium-containing optical material on the substrate. The wafer also includes at least one photodetecting layer on and bonded with the thin film lithium-containing optical material(s).

### CROSS REFERENCE TO OTHER APPLICATIONS

This application claims priority to U.S. Provisional Patent Application No. 63/467,279 entitled PHOTONICS WAFER INTEGRATING PHOTODETECTING MATERIALS filed May 17, 2023 which is incorporated herein by reference for all purposes.

### BACKGROUND OF THE INVENTION

Lithium-containing thin film electro-optic (TFEO) materials may include thin film lithium niobate (TFLN) and thin film lithium tantalate (TFLT). TFEO materials that contain lithium may have a large modulation in the index of refraction for a given applied electric field, which is desirable. Optical signals traveling in lithium-containing TFEO devices are often desired to be monitored. For example, thin film lithium-containing materials may be used for on-wafer short range communication for ultrahigh bandwidth links between electronic dies. It may be desirable to monitor the optical signals traveling between electronic dies to determine whether there are losses or other issues. However, materials such as TFLN and TFLT are transparent for wavelengths of approximately 400 nm through 1200 nm. Thus, TFLN and TLFT are not photodetecting materials and cannot be used to monitor optical signals. Instead, photodiodes are typically used.

Fully fabricated photodiodes are typically used in conjunction with lithium-containing TFEO materials. High quality photodiodes frequently include single crystal materials. Deposition of single-crystal materials (e.g. onto lithium-containing TFEO materials) is difficult or impossible. As a result, prefabricated photodiodes are typically used. Photodiodes are individually placed on an already-fabricated lithium-containing optical device and bonded to the device. This process is serial in nature and requires precise alignment. Thus, manufacturing times may be longer than desired. Furthermore, if a single bond fails, the entire optical device may not function as desired. This can adversely affect yield. Consequently, the manufacturing of photodiodes with optical devices incorporating lithium-containing TFEO materials may be slow, costly, and difficult to scale. Consequently, improved techniques for monitoring optical signals in lithium-containing TFEO devices are desired.

### BRIEF DESCRIPTION OF THE DRA WINGS

Various embodiments of the invention are disclosed in the following detailed description and the accompanying drawings.

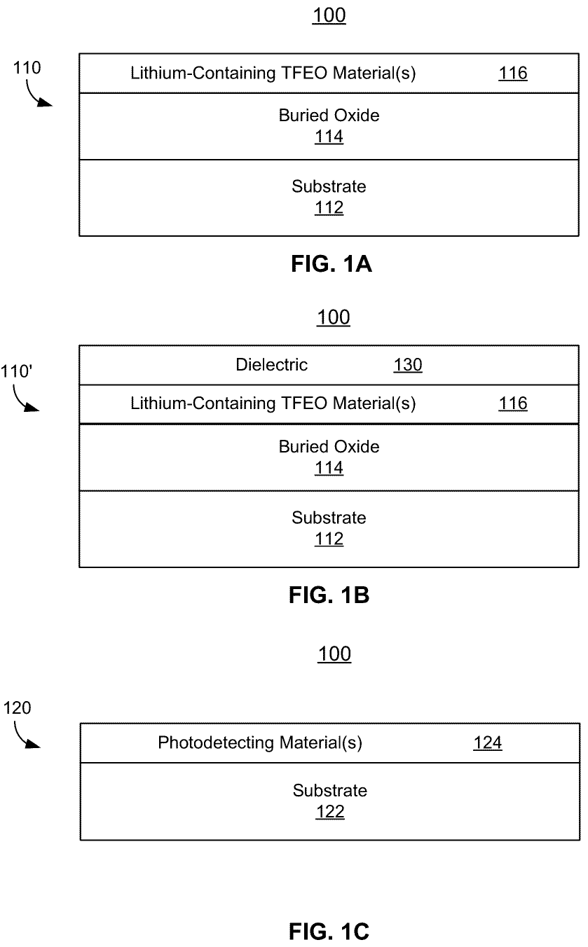

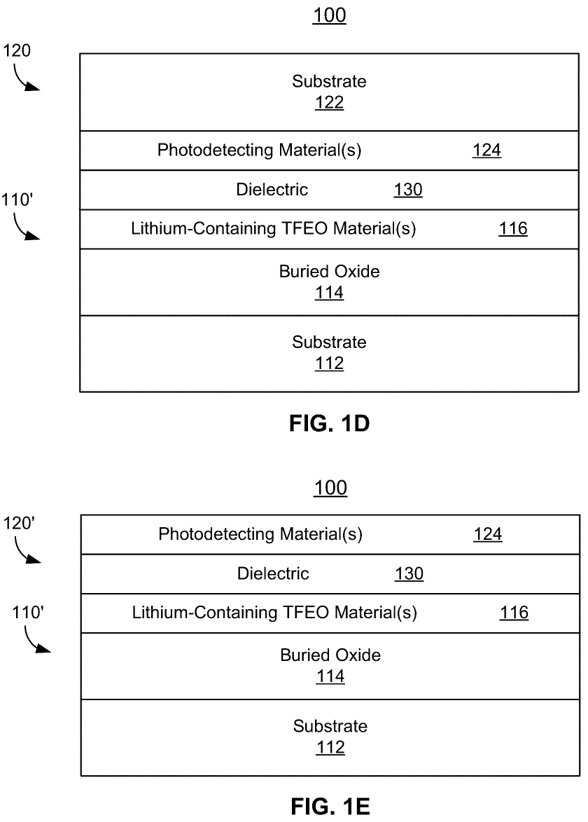

FIGS. 1A-1E depict an embodiment of a photonic device utilizing lithium-containing electro-optic material(s) during fabrication.

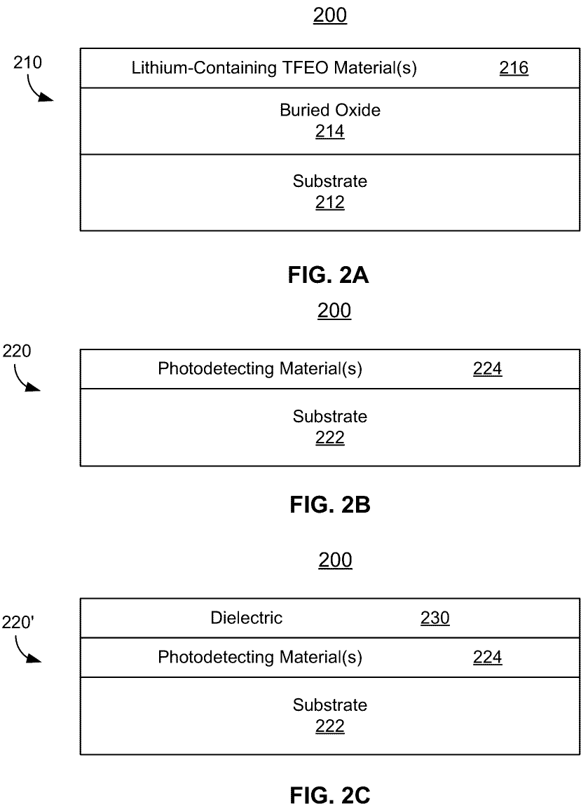

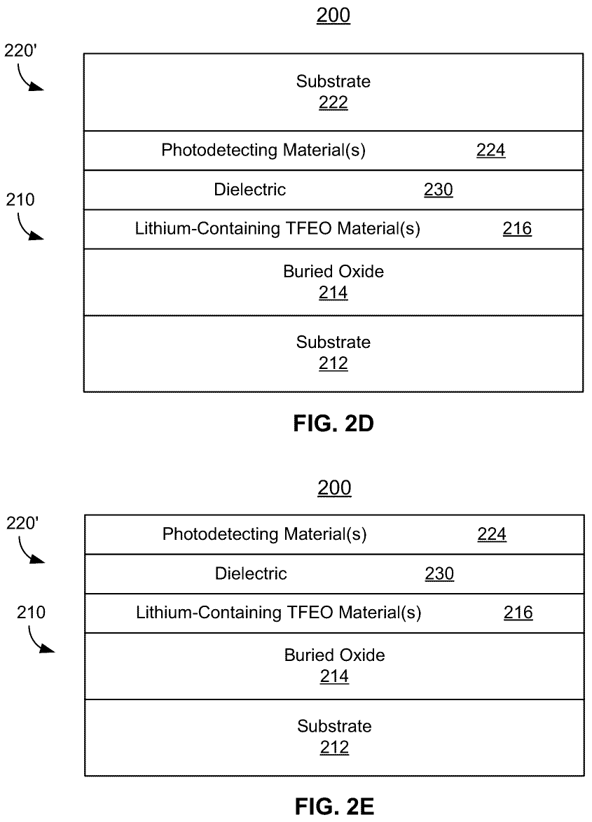

FIGS. 2A-2E depict an embodiment of a photonic device utilizing lithium-containing electro-optic material(s) during fabrication.

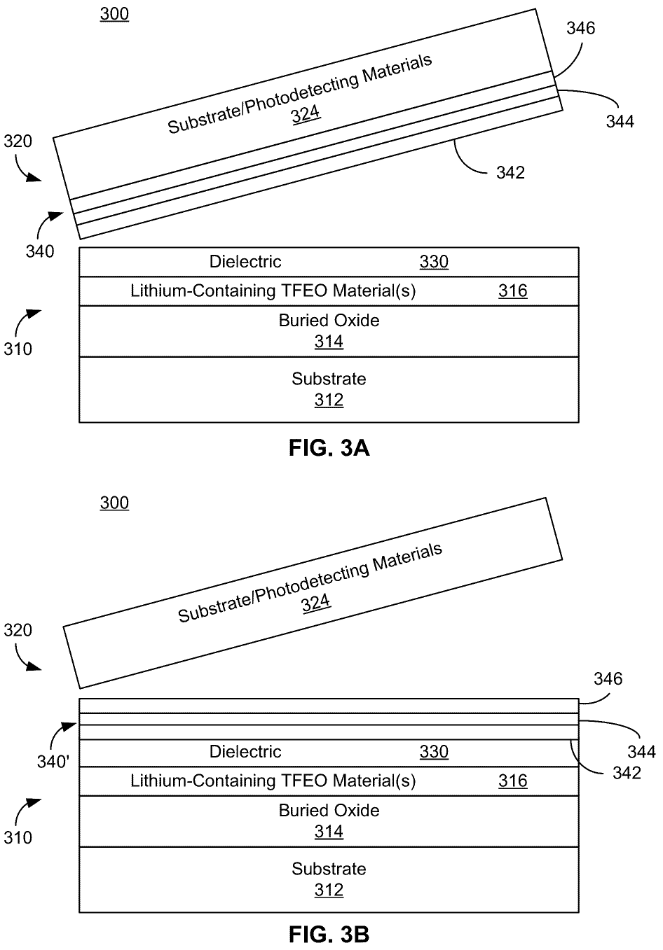

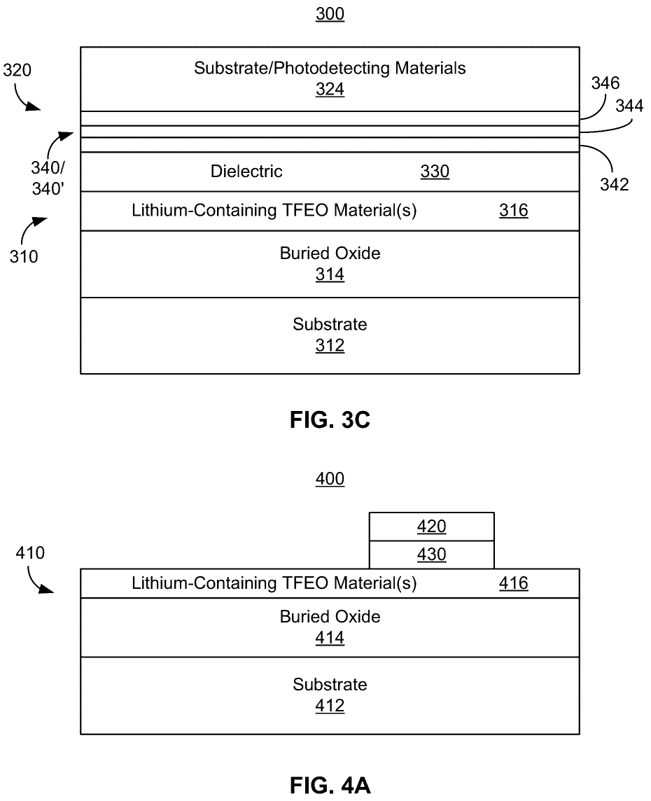

FIGS. 3A-3C depicts an embodiment of a photonic device utilizing lithium-containing electro-optic material(s) during fabrication.

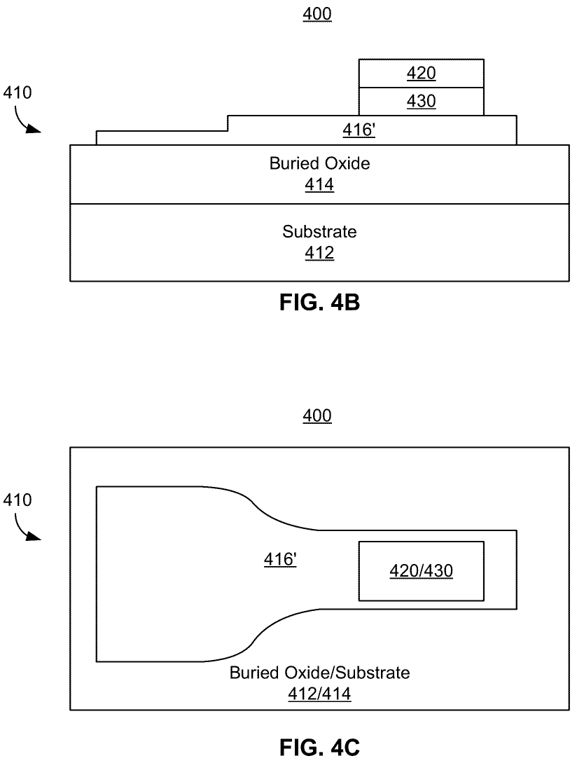

FIGS. 4A-4C depict an embodiment of a photonic device utilizing lithium-containing electro-optic material(s) during fabrication.

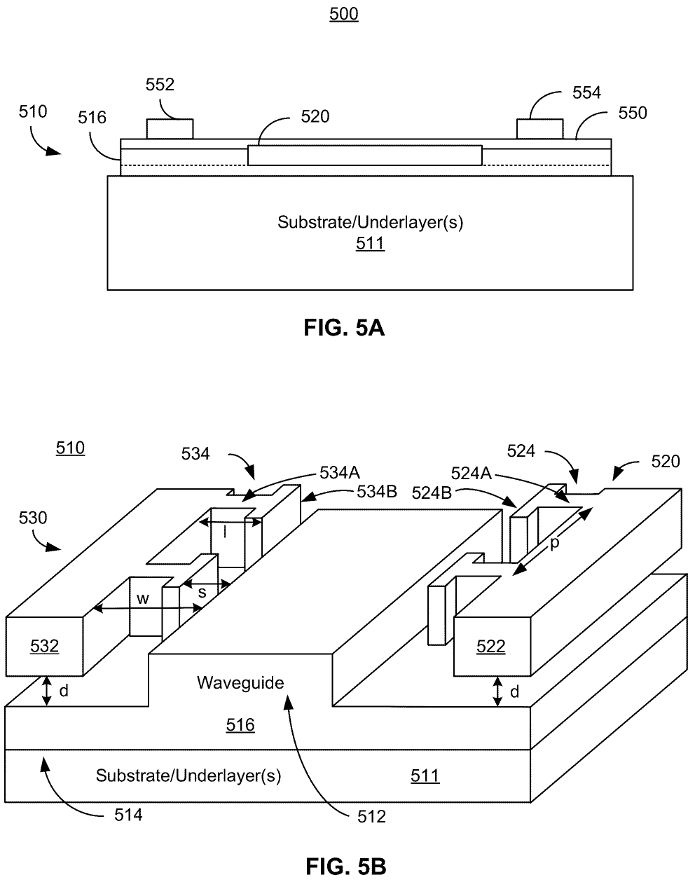

FIGS. 5A-5B depicts an embodiment of a photonic device utilizing lithium-containing electro-optic material(s).

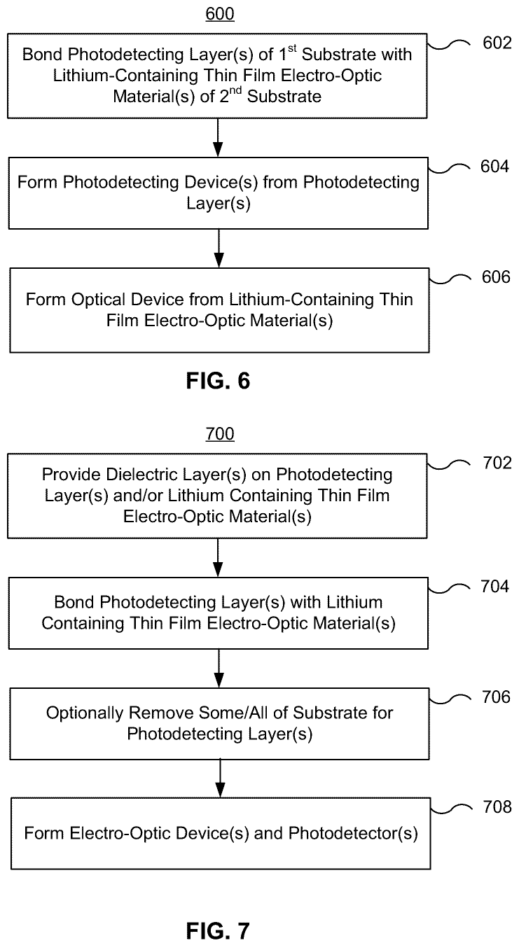

FIG. 6 is a flow chart depicting an embodiment of a method for providing photonic device utilizing lithium-containing electro-optic material(s).

FIG. 7 is a flow chart depicting an embodiment of a method for providing photonic device utilizing lithium-containing electro-optic material(s).

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A wafer for an integrated photonics system is described. The wafer includes a substrate and at least one thin film lithium-containing optical material on the substrate. The wafer also includes at least one photodetecting layer on and bonded with the at least one thin film lithium-containing optical material. The wafer may also include a dielectric layer between the thin film lithium-containing optical material(s) and the photodetecting layer(s). In some embodiments, the dielectric layer is provided on the thin film lithium-containing optical material(s) and the photodetecting layer(s) are bonded to the dielectric layer. In other embodiments, the dielectric layer is provided on the photodetecting layer(s) and bonded to the thin film lithium-containing optical material(s). The dielectric layer may include silicon dioxide and/or silicon nitride. Thus, the dielectric layer may include diffusion barrier layer(s). The photodetecting layer(s) may be part of or grown on an additional substrate, affixed to the thin film lithium-containing optical material(s), and at least part of the additional substrate removed.

An integrated photonics system is described. The integrated photonics system includes a substrate, an optical device and a photodetecting device. The optical device is on the substrate and includes thin film lithium-containing optical material(s). The optical device has a first footprint. The photodetecting device includes photodetecting material(s) and a second footprint. The photodetecting devices are on the optical device. The second footprint is within at least a portion of the first footprint. The photodetecting device may be bonded with the optical device. The integrated photonics system may also include a dielectric layer between the optical device and the photodetecting device. The dielectric layer may include diffusion barrier layer(s), such as silicon nitride. The dielectric layer may include silicon dioxide and/or silicon nitride. The dielectric layer is grown on the thin film lithium-containing optical material(s). In some embodiments, the dielectric layer is grown on the photodetecting material(s) and bonded to the thin film lithium-containing optical material(s). An oxide layer may be present between the substrate and the thin film lithium-containing optical material. The oxide layer may include silicon dioxide. The substrate may be a silicon substrate.

A method is described. The method includes bonding photodetecting layer(s) on a first substrate with thin film lithium-containing optical material(s) on a second substrate. Optical device component(s) are formed from the thin film lithium-containing optical material after the photodetecting layer(s) are bonded with the thin film lithium-containing optical material(s). The optical device component(s) having a first footprint. Photodetecting device(s) are formed from the photodetecting layer(s). The photodetecting device(s) have a second footprint within the first footprint. Thus, the photodetecting device(s) may be on top of and extend over an area not larger than the optical device component(s).

In some embodiments, a dielectric layer is provided on the photodetecting layer(s). In such embodiments, the thin film lithium-containing optical material(s) are bonded to the dielectric layer. Stated differently, the photodetecting layer(s) may be considered to be bonded to the thin film lithium-containing material(s) through the dielectric layer. The photodetecting layer(s) may be part of or grown on the first substrate. In such embodiments, at least part of the first substrate is removed before the optical device component is formed and before the photodetecting device is formed. The photodetecting layer may be ion implanted before the photodetecting layer is bonded with the at least one thin film lithium-containing optical material. In some embodiments, the photodetecting layer may include at least one of silicon, germanium, indium phosphide, gallium arsenide, or gallium nitride. The photodetecting layer or diode material is a heterostructure in some embodiments, for example a heterostructure associated with indium phosphide.

FIGS. 1A-1E depict an embodiment of photonic device 100 utilizing lithium-containing electro-optic material(s) during fabrication. For clarity, FIGS. 1A-1E are not to scale and not all components may be shown. More specifically, photonic device 100 is a wafer usable in forming a photonic device. Wafer 100 includes thin film electro-optic (TFEO) wafer 110 and photodetecting wafer 120. TFEO wafer 110 is a lithium-containing TFEO (LCTFEO) wafer 110. Referring to FIG. 1A, LCTFEO wafer 110 includes at least one layer including or consisting of a lithium-containing TFEO material (LCTFEO material(s)) 116). For example, LCTFEO material(s) 116 may include TFLN and/or TFLT. LCTFEO material(s) 116 are also a thin film. For example, before processing, LCTFEO material(s) 116 may have a total thickness of not more than three multiplied by the optical wavelengths for the optical signal carried in waveguide to be fabricated. In some embodiments, LCTFEO material(s) 116 has a total thickness of not more than two multiplied by the optical wavelengths. In some embodiments, the total thickness is not more than one multiplied by the optical wavelength or not more than 0.5 multiplied by the optical wavelengths. For example, the total thickness of LCTFEO material(s) 116 may be not more than three micrometers prior to fabricating electro-optic components such as waveguides. In some embodiment, the total thickness is not more than two micrometers. In some embodiment, the total thickness of LCTFEO material(s) 116 is not more than one micrometer. In some embodiments, the total thickness is not more than seven hundred nanometers. In some such embodiments, the total thickness of LCTFEO material(s) 116 is not more than four hundred nanometers. In some embodiments, the total thickness is at least fifty nanometers or one hundred nanometers. Fabrication of electro-optic components such as waveguides or mode converters involves removing some or all of LCTFEO material(s) 116 in various portions of LCTFEO wafer 110. Thus, the thickness(es) of such thin film electro-optic components may be small (e.g. five hundred nanometers or less). However, other thicknesses are possible in other embodiments.

LCTFEO wafer 110 also includes an underlying substrate 112 and buried oxide (BOX) layer 114. For example, substrate 112 may be a silicon substrate, while BOX layer 114 may include or consist of silicon dioxide. In some embodiments, substrate 112 may include other and/or additional layer(s), other and/or additional materials, or structures (e.g. trenches or apertures). BOX layer 114 may be desired to be thick. For example, BOX layer 114 may have a thickness of at least three micrometers and not more than ten micrometers. In some embodiments, BOX layer is at least five micrometers thick. In some embodiments, underlying substrate 112 (e.g. a silicon substrate) may be twenty micrometers thick or more.

Referring to FIG. 1B, during processing, one or more dielectric layers are provided on LCTFEO wafer 110. This is shown as dielectric layer 130 including in LCTFEO wafer 110′. Dielectric layer 130 may have low optical loss and facilitate wafer bonding of LCTFEO wafer 110. In some embodiments, dielectric layer 130 may function as a diffusion barrier (i.e. to slow or prevent diffusion) for lithium. For example, dielectric layer 130 may be or include one or more of silicon dioxide, silicon nitride, or silicon oxynitride. In some embodiments, the thickness of dielectric layer(s) is sufficient to function as a diffusion barrier. For example, dielectric layer 130 may be at least eighty nanometers thick. In some embodiments, dielectric layer 130 may be at least one hundred nanometers thick. In some embodiments, dielectric layer 130 may be omitted.

FIG. 1C depicts photodetecting wafer 120. Photodetecting wafer 120 includes photodetecting material(s) 124 on substrate 122. Photodetecting material(s) 124 may include or consist of silicon, germanium, and/or III-V materials such as indium phosphide, gallium arsenide, and/or gallium nitride. The material(s) used in photodetecting wafer 120 are capable of detecting the optical signals to be carried by LCTFEO wafer 110′. For example, photodetecting material(s) 124 may include silicon for the wavelengths in the optical range or germanium for wavelengths in the telecommunication range. In some embodiments, photodetecting material(s) 124 and substrate 122 include or consist of the same materials. For example, photodetecting material(s) 124 and substrate 122 may both be silicon. Moreover, photodetecting materials(s) 124 may have undergone processing, such as ion implantation.

FIG. 1D depicts wafer 100 after photodetecting wafer 120 has been bonded to LCTFEO wafer 110′. This may be achieved via a smart cut or analogous process. More specifically, photodetecting material(s) 124 are bonded to dielectric layer 130. In some embodiments, only a portion of photodetecting wafer 120 is bonded to LCTFEO wafer 110′. Substrate 122 may then be removed (or thinned). This is shown in FIG. 1E. Thus, remaining photodetecting wafer 120′ and LCTFEO wafer 110′ have integrated into a single wafer 100. A photonics device may be formed using wafer 100. More specifically, one or more photodetectors may be formed using photodetecting material(s) 124 and waveguide(s) and/or other components that carry the optical signal may be formed using LCTFEO material(s) 116.

Using wafer 100, a lithium-containing thin film electro-optic device may be provided. More specifically, wafer 100 may undergo further processing to form photodetectors, waveguides, and other components of a photonics device. Because both lithium-containing optical components and photodetectors can be fabricated, already-fabricated photodiodes need not be used. Instead, wafer 100 allows for the fabrication of multiple photodetectors in parallel from photodetecting material(s) 124 and multiple photonics devices in parallel from LCTFEO material(s) 116 (e.g. via photolithography). As a result, integration of photodetecting material(s) 124 and LCTFEO materials 116 has been moved from a back end of line process to a front end of line process. Fabrication of a photonics device that includes both waveguides and photodetectors may be simplified, made more repeatable and made more scalable. Thus, the benefits of LCTFEO photonics components may be combined with photodetection while achieving lower cost, higher yield, and/or improved scalability.

FIGS. 2A-2E depict an embodiment of photonic device 200 utilizing lithium-containing electro-optic material(s) during fabrication. For clarity, FIGS. 2A-2E are not to scale and not all components may be shown. Photonic device 200 is a wafer usable in forming a photonic device and is analogous to wafer 100. Wafer 200 includes LCTFEO wafer 210 and photodetecting wafer 220 that are analogous to LCFEO wafer 110 and photodetecting wafer 120, respectively. Referring to FIG. 2A, LCTFEO wafer 210 includes at least one layer including or consisting of LCTFEO material(s) 216, BOX 214, and substrate 212. LCTFEO material(s) 216 are analogous to LCTFEO material(s) 116. Similarly, BOX layer 214 and substrate 212 are analogous to BOX layer 114 and substrate 112, respectively. Thus, LCTFEO material(s) 216, BOX layer 214, and substrate 212 may have the same properties, thickness, function, and/or composition as LCTFEO material(s) 116, BOX layer 114, and substrate 112.

FIG. 2B depicts photodetecting wafer 220 that is analogous to photodetecting wafer 120. Photodetecting wafer 220 includes photodetecting material(s) 224 on substrate 222 that are analogous to photodetecting material(s) 124 and substrate 122. Thus, the properties, thickness, function, and/or composition of layers photodetecting material(s) 224 and substrate 222 are analogous to those of photodetecting material(s) 124 and substrate 122, respectively.

Referring to FIG. 2C, during processing, one or more dielectric layers 230 are provided on photodetecting wafer 220, forming photodetecting wafer 220′. Dielectric layer 230 is analogous to dielectric layer 130. Thus, dielectric layer 230 may have the same properties, thickness, function, and/or composition as dielectric layer 130. For example, dielectric layer 230 may have low optical loss and facilitate wafer bonding of photodetecting wafer 220.

FIG. 2D depicts wafer 200 after photodetecting wafer 220′ has been bonded to LCTFEO wafer 210. This may be achieved via a smart cut or analogous process. Thus, dielectric layer 230 has been bonded to LCTFEO material(s) 216. In some embodiments, only a portion of photodetecting wafer 220′ is bonded to LCTFEO wafer 210. Substrate 222 may then be removed (or thinned). This is shown in FIG. 2E. Thus, remaining photodetecting wafer 220′ and LCTFEO wafer 210 have integrated into a single wafer 200. A photonics device may be formed using wafer 200. More specifically, one or more photodetectors may be formed using photodetecting material(s) 224 and waveguide(s) and/or other components that carry the optical signal may be formed using LCTFEO material(s) 216.

Wafer 200 may share the benefits of wafer 100. Fabrication of a photonics device that includes both waveguides and photodetectors may be simplified, made more repeatable and made more scalable using wafer 200. Thus, the benefits of LCTFEO photonics components may be combined with photodetection while achieving lower cost, higher yield, and/or improved scalability.

FIGS. 3A-3C depicts an embodiment of photonic device 300 utilizing lithium-containing electro-optic material(s) fabricated in two ways. For clarity, FIGS. 3A-3C are not to scale and not all components may be shown. Photonic device 300 is a wafer usable in forming a photonic device and is analogous to wafer(s) 100 and/or 200. Wafer 300 includes LCTFEO wafer 310 and photodetecting wafer 320 that are analogous to LCTFEO wafer(s) 110/210 and photodetecting wafer(s) 120/220, respectively. LCTFEO wafer 310 includes at least one layer including or consisting of LCTFEO material(s) 316, BOX 314, and substrate 312. LCTFEO material(s) 316 are analogous to LCTFEO material(s) 116/216. Similarly, BOX layer 314 and substrate 312 are analogous to BOX layer 114 and substrate 112, respectively. LCTFEO wafer 310 also includes dielectric layer 330 analogous to dielectric layer(s) 130 and/or 230. In some embodiments, dielectric layer 330 may be omitted. LCTFEO material(s) 316, BOX layer 314, substrate 312, and dielectric layer 330 may have the same properties, thickness, function, and/or composition as LCTFEO material(s) 116/216, BOX layer 114/214, substrate 112/212, and dielectric layer 130/230.

Photodetecting wafer 320 is analogous to photodetecting wafer(s) 120/220. Photodetecting wafer 320 includes photodetecting material(s) 324 that may be on a substrate (not separately shown). Photodetecting material(s) 324 are analogous to photodetecting material(s) 124/224. Thus, the properties, thickness, function, and/or composition of layers photodetecting material(s) 324 are analogous to those of photodetecting material(s) 124/224 and substrate 122/222, respectively.

In FIG. 3A, dielectric layer 340 is shown as having been fabricated on photodetecting material(s) 322. Dielectric layer 340 includes multiple layers 342, 344, and 346. In FIG. 3B, dielectric layer 340′ is shown as having been fabricated on LCTFEO wafer 310. Dielectric layer 340′ is analogous to dielectric layer 340 and includes multiple layers 342, 344, and 346. Although dielectric layer 330 is depicted in FIGS. 3A and 3B, in some embodiments, dielectric layer 340 and/or 340′ may replace dielectric layer 330. Thus, dielectric layer 340/340′ may be deposited or grown on photodetecting wafer 320 or LCTFEO wafer 310.

Dielectric layer 340/340′ is a lithium barrier layer. In some embodiments, layers 342 and 346 include or consist of silicon dioxide, while layer 344 includes or consists of silicon nitride. Silicon nitride layer 344 may be at least sixty nanometers thick to reduce or prevent diffusion of lithium through silicon nitride layer 344. In some embodiment, silicon nitride layer 344 is at least eighty nanometers thick. In some embodiments, silicon nitride layer 344 is at least one hundred nanometers and not more than five hundred nanometers thick. Silicon nitride layer 344 may be not more than three hundred nanometers thick. Dielectric layer 340 may be not more than one micron thick. Silicon nitride layer 344 may have a large coefficient of thermal expansion (CTE) mismatch with photodetecting material(s) 324 and/or LCTFEO material(s) 316. Further, deposition of silicon nitride 344 directly onto photodetecting material(s) 324 and/or LCTFEO material(s) 316 may result in a high amount of stress in wafer 320 and/or in peeling of silicon nitride layer 344. Consequently silicon nitride layer 344 is deposited between silicon dioxide layer 342 and 346.

FIG. 3C depicts wafer 300 after photodetecting wafer 320 has been bonded to LCTFEO wafer 310. Thus, photodetecting wafer 320 and LCTFEO wafer 310 have been integrated into a single wafer 300 in which a dielectric layer 340/340′ including a lithium barrier layer has been provided. A photonics device may be formed using wafer 300. One or more photodetectors may be formed using photodetecting material(s) 324. Waveguide(s) and/or other components that carry the optical signal may be formed using LCTFEO material(s) 316.

Wafer 300 may share the benefits of wafer 100 and/or 200. Fabrication of a photonics device that includes both waveguides and photodetectors may be simplified, made more repeatable and made more scalable using wafer 300. Further, diffusion of lithium between LCTFEO material(s) 316 used in forming optical components such as waveguides may be reduced or prevented by dielectric layer 340/340′. Thus, the benefits of LCTFEO photonics components may be combined with photodetection while achieving lower cost, higher yield, and/or improved scalability.

FIGS. 4A-4C depict an embodiment of photonic device 400 utilizing lithium-containing electro-optic material(s) during fabrication. For clarity, FIGS. 4A-4C are not to scale and not all components may be shown. Photonic device 400 includes LCTFEO wafer 410 and photodetector 420 that are analogous to LCTFEO wafer(s) 110/210/310 and photodetecting material(s) 124/224/324, respectively. LCTFEO wafer 410 includes at least one layer including or consisting of LCTFEO material(s) 416, BOX 414, and substrate 412. LCTFEO material(s) 416 are analogous to LCTFEO material(s) 116/216/316. Similarly, BOX layer 414 and substrate 412 are analogous to BOX layer 114/214/314 and substrate 112/212/312, respectively. Also shown is dielectric layer 430 analogous to dielectric layer(s) 130, 230, 330, 340, and/or 340′. In some embodiments, dielectric layer 430 may be omitted. LCTFEO material(s) 416, BOX layer 414, substrate 412, and dielectric layer 430 may have the same properties, thickness, function, and/or composition as LCTFEO material(s) 116/216/316, BOX layer 114/214/314, substrate 112/212/312, and dielectric layer 130/230/330/340/340′, respectively. Photodetector 420 has been formed from photodetecting material(s) analogous to photodetecting material(s) 124/224/324.

FIG. 4A depicts photonic device 400 after a photodetector 420 has been formed. Although a single photodetector 420 is shown, multiple may be formed. Photodetector 420 and dielectric layer 430 have been etched through. However, some or all of LCTFEO material(s) remain.

FIGS. 4B and 4C depict photonics device 400 after optical structure 416′ has been formed. FIG. 4B is a cross-sectional view, while FIG. 4C is a top view. Optical structure 416′ may include waveguide(s), mode converter(s), polarization beam rotator(s), and/or other components that carry optical signals. Other optical structure(s) (not shown) may also be formed from LCTFEO material(s) 416. Optical structure 416′ is between photodetector 420 and substrate 412 and formed after photodetector 420. Thus, the footprint (shape and size in plane) of optical structure 416 (shown in FIG. 4C) is the same size as or larger than the footprint of photodetector 420 (shown in FIG. 4C). Although photodetector 420 and dielectric layer 430 are shown as having the same footprint, in some embodiments, photodetector 420 may have a smaller footprint than dielectric layer 430. Further, particular shapes are shown for the footprints of photodetector 420 and optical structure 416′. However, nothing prevents photodetector 420 and/or optical structure 416′ from having a different shape.

Photonics device 400 may share the benefits of wafer 100, 200, and/or 300. Fabrication of photonics 400 may be simplified, made more repeatable and made more scalable. Further, diffusion of lithium between LCTFEO material(s) 416 used in forming optical components such as waveguides may be reduced or prevented by dielectric layer 430. Thus, the benefits of LCTFEO photonics components may be combined with photodetection while achieving lower cost, higher yield, and/or improved scalability.

FIGS. 5A-5B depict an embodiment of photonics device 500. FIG. 5A depicts a cross-sectional view of photonics device 500. FIG. 5B depicts a perspective view of a portion of photonics device 500. For clarity, FIGS. 5A and 5B are not to scale and not all components are shown. System 500 includes an electro-optic device 510, photodetectors 552 and 554, and underlying substrate/underlayers 511. Electro-optic device 510 includes LCTFEO waveguide 516 and electrodes 520 and 522. Photodetectors 552 and 554 and waveguide 516 may be formed from a wafer analogous to wafer(s) 100, 200, and/or 300, and/or photonics device 400.

FIG. 5B depicts an embodiment of a portion of electro-optic device 510 including LCTFEO materials. For clarity, top cladding layer(s) are not shown. Such cladding layer(s) would cover the portions of the device depicted. Further, electro-optic device 510 may be configured differently in other embodiments. Electro-optic device 510 includes a substrate and/or underlayers 511, lithium-containing thin film electro-optic waveguide 516 that includes ridge waveguide 512 and slab portion 514, and electrodes 520 and 530. Electrode 520 includes channel region 522 and extensions 524. Electrode 530 includes channel region 532 and extensions 534. Substrate 511 may include an underlying substrate such as Si and a BOX layer (not separately shown) in FIGS. 5A-5B.

Electro-optic waveguide 516 is or includes a LCTFEO layer that may include or consist of LN and/or LT. In some embodiments, the nonlinear optical material for LCTFEO waveguide 516 is formed from a thin film layer. For example, the thin film may have a total thickness (e.g. of thin film or slab portion 514 and ridge waveguide portion 512) of not more than three multiplied by the optical wavelengths for the optical signal carried in waveguide 512 before processing. In some embodiments, the thin film has a total thickness of not more than two multiplied by the optical wavelengths. In some embodiments, the nonlinear optical material has a total thickness of not more than one multiplied by the optical wavelength. In some embodiments, the nonlinear optical material has a total thickness of not more than 0.5 multiplied by the optical wavelengths. For example, the thin film may have a total thickness of not more than three micrometers as-deposited. In some embodiment, the thin film has a total thickness of not more than two micrometers. In some embodiment, the thin film has a total thickness of not more than one micrometer. In some embodiments, the thin film has a total thickness of not more than seven hundred nanometers. In some such embodiments, the thin film has a total thickness of not more than four hundred nanometers. In some embodiments, the thin film has a thickness of at least one hundred nanometers.

The thin film nonlinear optical material may be fabricated into waveguide 516 utilizing photolithography. For example, ultraviolet (UV) and/or deep ultraviolet (DUV) photolithography may be used to pattern masks for the nonlinear optical material. For DUV photolithography, the wavelength of light used is typically less than two hundred and fifty nanometers. To fabricate the waveguide, the thin film nonlinear optical material may undergo a physical etch, for example using dry etching, reactive ion etching (RIE), inductively coupled plasma RIE. In some embodiments, a chemical etch and/or electron beam etch may be used. Waveguide 512 may thus have improved surface roughness. For example, the sidewall(s) of ridge 512 may have reduced surface roughness. For example, the short range root mean square surface roughness of a sidewall of the ridge 512 is less than ten nanometers. In some embodiments, this root mean square surface roughness is not more than five nanometers. In some cases, the short range root mean square surface roughness does not exceed two nanometers. In some embodiments, optical device 510B has an optical loss in signal through the modulator of not more than 5 dB/cm. In some embodiments, the optical loss is not more than 2 dB/cm. In some such embodiments, the optical loss for LCTFEO waveguide 516 is less than 1.0 dB/cm. For example, this loss may be not more than 0.5 dB/cm in some embodiments. In some embodiments, the height of ridge waveguide 512 is selected to provide a confinement of the optical mode such that there is a 50 dB reduction in intensity from the intensity at the center of ridge waveguide 512 at ten micrometers from the center of ridge waveguide 512. For example, the height of ridge waveguide 512 is on the order of a few hundred nanometers in some cases. The height of ridge waveguide 512 may be not more than three hundred nanometers. In some embodiments, the height of ridge waveguide 512 is not more than two hundred nanometers. In some embodiments, the height of ridge waveguide 512 is not more than one hundred nanometers. However, other heights are possible in other embodiments. A portion of waveguide 512 is proximate to electrodes 520 and 530 along the direction of transmission of the optical signal (e.g. from the input of the optical signal through waveguide 512 to the modulated optical signal output). The portion of waveguide 512 proximate to electrodes 520 and 530 may the lengths described above, for example a length greater than two millimeters in some embodiments, and greater than two or more centimeters in some such embodiments. Such lengths are possible at least in part because of the low optical losses per unit length for waveguide 512 described herein. Further, the portion of waveguide 512 proximate to electrodes 520 and 530 has an optical mode cross-sectional area that is small, for example not extending significantly beyond the edges of ridge waveguide 512. In some embodiments, ridge waveguide 512 has an optical mode cross-sectional area of less than the square of the wavelength of the optical signal in the nonlinear optical material(s) (e.g. λ²). In some embodiments, the optical mode cross-sectional area is less than 3 multiplied by λ², where λ is the wavelength of the optical signal in the waveguide.

Electrodes 520 and 530 apply electric fields to waveguide 512. Electrode(s) 520 and/or 530 may be fabricated using deposition techniques, such as electroplating, and photolithography to shape the electrode 120 and/or 530. The resulting electrode 520 and/or 530 may have a lower frequency dependent electrode loss, in the ranges described herein. Electrode 520 includes a channel region 522 and extensions 524 (of which only one is labeled in FIG. 5B). Electrode 530 includes a channel region 532 and extensions 534 (of which only one is labeled in FIG. 5B). In some embodiments, extensions 524 or 534 may be omitted from electrode 520 or electrode 530, respectively. Extensions 524 and 534 are closer to waveguide 512 than channel region 522 and 532, respectively, are. For example, the distance s from extensions 524 and 534 to waveguide ridge 512 is less than the distance w from channels 522 and 532 to waveguide ridge 512. In the embodiment shown in FIG. 5B, extensions 524 and 534 are at substantially the same level as channel regions 522 and 532, respectively. In some embodiments, the extensions may protrude above and/or below the channel regions in addition to or in lieu of being at the same level. Further, if electrodes 520 and 530 are above ridge waveguide 512, extensions 524 and 534 may extend over the top of ridge waveguide 512. Stated differently, extensions 524 and 534 may be closer than the width of ridge waveguide 512.

Extensions 524 and 534 are in proximity to waveguide 512. For example, extensions 524 and 534 are a vertical distance, d from LCTFEO waveguide 516. The vertical distance to LCTFEO waveguide 516 may depend upon the cladding (not shown in FIG. 5B) used. The distance d is highly customizable in some cases. For example, d may range from zero (or less if electrodes 520 and 530 contact or are embedded in thin film portion 514) to greater than the height of ridge 512. However, d is generally still desired to be sufficiently small that electrodes 520 and 530 can apply the desired electric field to waveguide 512. Extensions 524 and 534 are also a distance, s, from ridge 512. Extensions 524 and 534 are desired to be sufficiently close to LCTFEO waveguide 516 (e.g. close to ridge 512) that the desired electric field and index of refraction change can be achieved. However, extensions 524 and 534 are desired to be sufficiently far from LCTFEO waveguide 516 (e.g. from ridge 512) that their presence does not result in undue optical losses. Although the distance s is generally agnostic to specific geometry or thickness of LCTFEO waveguide 516, s may be selected to allow for both transverse electric and transverse optical modes that are confined differently in LCTFEO waveguide 516. However, the optical field intensity at extensions 524 and 534 (and more particularly at sections 524B and 534B) is desired to be reduced to limit optical losses due to absorption of the optical field by the conductors in extensions 524 and 534. Thus, s and/or d are sufficiently large that the total optical loss for waveguide 512, including losses due to absorption at extensions 524 and 534, is not more than 50 dB or less in some embodiments, 5 dB or less in some embodiments, and/or 4 dB or less in some embodiments. In some embodiments, s is selected so that optical field intensity at extensions 524 and 534 is less than −10 dB of the maximum optical field intensity in waveguide 512. In some embodiments, s is chosen such that the optical field intensity at extensions 524 and 534 is less than −40 dB of its maximum value in the waveguide. For example, extensions 524 and/or 534 may be at least two micrometers and not more than 2.5 micrometers from ridge 512 in some embodiments. In some embodiments, extensions 524 and/or 534 may extend over waveguide 512 if d is greater than the height of the ridge for waveguide 512.

In the embodiment shown, extensions 524 have a connecting portion 524A and a retrograde portion 524B. Retrograde portion 524B is so named because a part of retrograde portion may be antiparallel to the direction of signal transmission through electrode 520. Similarly, extensions 534 have a connecting portion 5234A and a retrograde portion 534B. Thus, extensions 524 and 534 have a “T”-shape. In some embodiments, other shapes are possible. For example, extensions 524 and/or 534 may have an “L”-shape, may omit the retrograde portion, may be rectangular, trapezoidal, parallelogram-shaped, may partially or fully wrap around a portion of waveguide 512, and/or have another shape. Similarly, channel regions 522 and/or 532, which are shown as having a rectangular cross-section, may have another shape. Further, extensions 524 and/or 534 may be different sizes. Although all extensions 524 and 534 are shown as the same distance from ridge 512, some of extensions 524 and/or some of extensions 534 may be different distances from ridge 512. Channel regions 522 and/or 532 may also have a varying size. In some embodiments, extensions 524 and 534, respectively, are desired to have a length, 1 (e.g. 1=w−s), that corresponds to a frequency less than the Bragg frequency of the signal for electrodes 520 and 530, respectively. Thus, the length of extensions 524 and 534 may be desired to be not more than the microwave wavelength of the electrode signal divided by π at the highest frequency of operation for electrodes 520 and 530. In some embodiments, the length of extensions 524 and 534 is desired to be less than the microwave wavelength divided by twelve. For example, if the maximum operation frequency is 300 GHz, which corresponds to a microwave wavelength of 440 micrometers in the substrate, extensions 524 and 534 are desired to be at smaller than approximately 37 micrometers. Individual extensions 524 and/or 534 may be irregularly spaced or may be periodic. Periodic extensions have a constant pitch. In some embodiments, the pitch, p, is desired to be a distance corresponding to a frequency that is less than the Bragg frequency, as discussed above with respect to the length of extensions 524 and 534. Thus, the pitch for extensions 524 and 534 may be desired to be not more than the microwave wavelength of the electrode signal divided by π at the highest frequency of operation for electrodes 520 and 530. In some embodiments, the pitch is desired to be less than the microwave wavelength divided by twelve. In some embodiments, the pitch is desired to be less than the microwave wavelength divided by seventy two, allowing for a low ripple in group velocity.

Extensions 524 and 534 are closer to ridge 512 than channels 522 and 532, respectively, are (e.g. s<w). In some embodiments, a dielectric cladding (not explicitly shown in FIG. 5B) resides between electrodes 520 and 530 and LCTFEO waveguide 516. As discussed above, extensions 524 and 534 are desired to have a length (w−s) that corresponds to a frequency less than the Bragg frequency of the signal for electrodes 520 and 530, respectively. Extensions 524 and 534 are also desired to be spaced apart from ridge 512 as indicated above (e.g. such that the absorption loss in waveguide 512 can be maintained at the desired level, such as 50 dB or less). The length of the extensions 524 and 534 and desired separation from ridge 512 (e.g. s) are considered in determining w. Although described in the context of a horizontal distance, the distance between electrode structures and the waveguide also applies for vertical configurations. Other distances between ridge waveguide 512 and channel regions 522 and/or 532 are possible.

Extensions 524 and 534 protrude from channel regions 522 and 532, respectively, and reside between channel regions 522 and 532, respectively, and waveguide 510. As a result, extensions 524 and 534 are sufficiently close to waveguide 510 to provide an enhanced electric field at waveguide 510. Consequently, the change in index of refraction induced by the electric field is increased. In contrast, channel regions 522 and 532 are spaced further from waveguide 510 than the extensions 524 and 534. Thus, channel region 522 is less affected by the electric field generated by electrode 530/extensions 534. Electrical charges have a reduced tendency to cluster at the edge of channel region 522 closest to electrode 530. Consequently, current is more readily driven through central portions channel region 522 and the electrode losses in channel region 522 (and electrode 520) may be reduced. Because microwave signal losses through electrodes 520 and 530 may be reduced, a smaller driving voltage may be utilized for electrode(s) 520 and/or 530 and less power may be consumed by optical device 500. In addition, the ability to match the impedance of electrode 520 with an input voltage device (not shown) may be improved. Such an impedance matching may further reduce electrode signal losses for optical device 500. Moreover, extensions 524 and 534 may affect the speed of the electrode signal through electrodes 520 and 530. Thus, extensions 524 and 534 may be configured to adjust the velocity of the electrode signal to match the velocity of the optical signal in waveguide 510. Consequently, performance of optical device 500 may be improved.

Photonics device 500 may share the benefits of wafer 100, 200, and/or 300 and photonics device 400. Fabrication of photonics 500 may be simplified, made more repeatable and made more scalable. Thus, the benefits of LCTFEO photonics components may be combined with photodetection while achieving lower cost, higher yield, and/or improved scalability. The use of extensions 524 and 534 may improve performance. Use of electrodes 520 and 530 having extensions 524 and 534, respectively, may reduce microwave losses, allow for a large electric field at ridge waveguide 512 and improve the propagation of the microwave signal through electrodes 520 and 530, respectively. Further, the low surface roughness of the sidewalls of waveguide 512 may reduce optical losses. Consequently, performance of electro-optic device 510 may be significantly enhanced.

FIG. 6 is a flow chart depicting an embodiment of method 600 for providing photonic device utilizing lithium-containing electro-optic material(s). Method 600 is described in the context of processes that may have sub-processes. Although described in a particular order, another order not inconsistent with the description herein may be utilized.

Photodetecting layer(s) for a first substrate are bonded with LCTFEO material(s) on a second substrate, at 602. In some embodiments, 602 includes using a smart cut process. Further, 602 may not bond a photodetecting layer directly to a LCTFEO layer. Instead, an intervening layer, such as a dielectric layer, may be fabricated on one of the substrates prior to bonding.

Photodetecting device(s) are formed from the photodetecting layer(s), at 604. In some embodiments, 604 includes etching through the photodetecting layer(s). The portion of the LCTFEO layer(s) around the photodetecting device(s) may be exposed by 604.

Optical device component(s) are formed from the LCTFEO material(s) after the photodetecting layer(s) are bonded with the LCTFEO material(s), at 606. In some embodiments, some portions of the LCTFEO material(s) are etched through, while other portions are not. Thus, the optical device component(s) have footprint(s) larger than the footprint(s) of the photodetecting device(s) on the optical device component(s). Fabrication of the photonics device may then be completed. For example, cladding, electrodes, and/or other devices may be provided.

For example, method 600 may be used to fabricate photonics device 400. Photodetecting material(s) for photodetector 420 may be bonded to LCTFEO wafer 410, at 602. Dielectric layer 430 may have been fabricated on the photodetecting material(s) or on LCTFEO material(s) 416. Photodetector 420 is formed at 604. For photonics device 400, both the photodetecting material(s) and the dielectric layer are etched through. Thus, structures 420 and 430 are formed. Optical structure 416′ may be formed by etching LCTFEO material(s) 416, at 606.

Using method 600, a photonics device may be formed. Method 600 may simplify fabrication of the device that includes both LCTFEO optical components and photodetectors. Further, manufacturing may be more repeatable and made more scalable because individual prefabricated photodetectors need not be individually aligned and bonded with the photonics device. Thus, the benefits of LCTFEO photonics components may be combined with photodetection while achieving lower cost, higher yield, and/or improved scalability.

FIG. 7 is a flow chart depicting an embodiment of method 700 for providing photonic device utilizing lithium-containing electro-optic material(s). Method 700 is described in the context of processes that may have sub-processes. Although described in a particular order, another order not inconsistent with the description herein may be utilized.

Dielectric layer(s) may be provided on photodetecting layer(s) for a first substrate or on LCTFEO material(s) for a second substrate, at 702. In some embodiments, a single dielectric layer, such as SiO2, may be deposited on the substrate. In some embodiments, multiple dielectric layers are deposited at 702. For example, a trilayer of silicon dioxide-silicon nitride-silicon dioxide may be used. In some embodiments, 702 includes depositing a lithium barrier layer, such as silicon nitride. The photodetecting layer(s) for the first substrate are bonded with LCTFEO material(s) on the second substrate, at 704. In some embodiments, 704 is analogous to 602.

Some or all of the substrate for the photodetecting layer(s) is removed, at 706. Thus, the wafer is thinned at 706. Photodetecting device(s) and optical components are formed from the photodetecting and LCTFEO layer(s), at 708. In some embodiments, 708 includes etching the photodetecting layer(s) and the LCTFEO material(s). Fabrication of the photonics device may then be completed. For example, cladding, electrodes, and/or other devices may be provided.

For example, method 700 may be used to fabricate photonics device 400 using wafers 100, 200, and/or 300. Dielectric layer 430 is provided, at 702. In some embodiments, 702 includes providing multiple layers, such as layers 342, 344, and 346. Photodetecting material(s) for photodetector 420 may be bonded to LCTFEO wafer 410, at 704. The substrate for photodetector 420 may be removed, at 706. Photodetector 420 and optical structure 416′ are formed at 708. Thus, structures 420, 430, and 416′ are formed.

Using method 700, a photonics device may be formed. Method 700 may simplify fabrication of the device that includes both LCTFEO optical components and photodetectors. Further, manufacturing may be more repeatable and made more scalable because individual prefabricated photodetectors need not be individually aligned and bonded with the photonics device. Thus, the benefits of LCTFEO photonics components may be combined with photodetection while achieving lower cost, higher yield, and/or improved scalability.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A wafer for an integrated photonics system, comprising:
a substrate;
at least one thin film lithium-containing optical material on the substrate; and
at least one photodetecting layer on and bonded with the at least one thin film lithium-containing optical material.

2. The wafer of claim 1, further comprising:
a dielectric layer between at least one thin film lithium-containing optical material and the at least one photodetecting layer.

3. The wafer of claim 2, wherein the dielectric layer is provided on the at least one thin film lithium-containing optical material and the at least one photodetecting layer is bonded to the dielectric layer.

4. The wafer of claim 2, wherein the dielectric layer is provided on the at least one photodetecting layer and bonded to the at least one thin film lithium-containing optical material.

5. The wafer of claim 2, wherein the dielectric layer includes at least one of silicon dioxide or silicon nitride.

6. The wafer of claim 1, wherein the at least one photodetecting layer is part of or grown on an additional substrate, affixed to the at least one thin film lithium-containing optical material, and at least a portion of the additional substrate removed.

7. An integrated photonics system, comprising:
a substrate;
an optical device on the substrate and including at least one thin film lithium-containing optical material, the optical device having a first footprint; and
a photodetecting device including at least one photodetecting material, having a second footprint, and on the optical device, wherein the second footprint lies within at least a portion of the first footprint.

8. The integrated photonics system of claim 7, wherein the photodetecting device is bonded with the optical device.

9. The integrated photonics system of claim 8, further comprising:
a dielectric layer between the optical device and the photodetecting device, the dielectric layer including at least one of silicon dioxide or silicon nitride.

10. The integrated photonics system of claim 9, wherein the dielectric layer is grown on the at least one thin film lithium-containing optical material.

11. The integrated photonics system of claim 9, wherein the dielectric layer is grown on the at least one photodetecting material and bonded to the at least one thin film lithium-containing optical material.

12. The integrated photonics system of claim 9, wherein the dielectric layer further includes a diffusion barrier layer between the at least one photodetecting device and the at least one thin film lithium-containing optical material.

13. The integrated photonics system of claim 7, further comprising:
an oxide layer between the substrate and the at least one thin film lithium-containing optical material.

14. The integrated photonics system of claim 12, wherein the oxide layer includes silicon dioxide and the substrate is a silicon substrate.

15. A method, comprising:
bonding at least one photodetecting layer on a first substrate with at least one thin film lithium-containing optical material on a second substrate;
forming at least one optical device component from the at least one thin film lithium-containing optical material after the at least one photodetecting layer is bonded with the at least one thin film lithium-containing optical material, the at least one optical device component having a first footprint; and
forming at least one photodetecting device from the at least one photodetecting layer, the at least one photodetecting device having a second footprint within the first footprint.

16. The method of claim 15, further comprising:
providing a dielectric layer on the at least one thin film lithium-containing optical material; and
wherein the at least one photodetecting layer is bonded to the dielectric layer.

17. The method of claim 15, further comprising:
providing a dielectric layer on the at least one photodetecting layer; and
wherein the dielectric layer is bonded to the at least one thin film lithium-containing optical material.

18. The method of claim 15, wherein the at least one photodetecting layer is grown on or part of the first substrate and wherein the method further includes:
removing at least a portion of the first substrate before the at least one optical device component is formed and before the at least one photodetecting device is formed.

19. The method of claim 18, wherein the photodetecting layer is ion implanted before the photodetecting layer is bonded with the at least one thin film lithium-containing optical material.

20. The method of claim 15, wherein the photodetecting layer includes at least one of silicon, germanium, indium phosphide, gallium arsenide, or gallium nitride.
